(19) United States
(12) Patent Application Publication
(10) Pub. No.: US 2008/0221976 A1
(43) Pub. Date: Sep. 11, 2008

(54) Web-based financial services and products client lead generation system and method

(76) Inventors: Stephen P. Henrie, San Diego, CA (US); Christopher J. Cunningham, La Jolla, CA (US); David Paul Winterbourne, Tucson, AZ (US); Matthew Robert Olsen, Tucson, AZ (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/074,886

(22) Filed: Mar. 7, 2008

Related U.S. Application Data
(60) Provisional application No. 60/893,620, filed on Mar. 7, 2007.

(51) Int. Cl. G06Q 99/00; G06Q 40/00

(52) U.S. Cl. 705/10

(57) ABSTRACT

A web-based method for customer lead generation employing a system of need-based calculators which when chosen by a consumer identify a product or service need without the consumer having to actively do so. The user-specific calculators provide the consumer with calculations to be considered for a specific product or service being considered for purchase. Data entry windows in the calculator provide the consumer input positions for data needed for the calculations and concurrently capture data for a potential vendor to employ in making a bid. The consumer thereby identifies a need for a product or service and provides data for use in providing that service that may be forwarded to vendors.

### FIELD OF THE INVENTION

This application claims priority from U.S. Provisional Patent Application Ser. No. 60/893,620 filed Mar. 7, 2007, incorporated herein in its entirety by reference.

The disclosed method invention relates a lead generation system and method for identifying potential customers for products and services. More particularly, it relates to a marketing and segmentation method for potential customers and clients needing financial services, or products, through the employment of web-based, user-chosen, financial calculators adapted to identify particular clients in need of financial services which are available from individual financial service vendors, and to timely communicate client leads so generated to financial services providers who subscribe to the service.

### BACKGROUND OF THE INVENTION

Customers for financial services vary widely and as such, providers of such services are equally distinct. For instance, a potential borrower for a home loan generally needs the services of a mortgage broker or mortgage lender. A potential client for an auto loan however requires the services of a financial service provider which offers auto loans. Even these two groups of potential clients have subgroups based on credit worthiness, geography, the age of the asset being borrowed upon, and any number of other factors. It is most helpful to the potential customer, if their individual criteria can be examined and communicated to a service provider matched ideally to their individual circumstance.

Web based email marketing is frequently employed to market such financial services. Modern e-mail marketing is founded on the basis of using massive databases, which permit companies to segment customers into demographic or other clusters. Analysts query databases at marketers' requests to produce lists of customers and their e-mail addresses into various subgroups, which are then used in batch communications to send members of those subgroups almost identical messages at infrequent intervals, according to the company's schedule.

Database marketing and segmentation have evolved with the advent of the web to include a type of one-to-one marketing by creating personalized messages for individual customers, though it does not guarantee relevancy of the content to the customer's needs.

However, the one question that is rarely asked is “when should the message be delivered?” In marketing, especially of a financial service, timing is the usually the primary factor in ensuring that the message or offer received by the potential customer is actually read or examined. If received too early the message may be examined but then forgotten. If communicated too late, the communication is ignored because by the nature of financial services, the client has gone elsewhere.

Additionally, most people prefer not to receive email and advertisements from companies and go to great lengths to not clutter their email with junk mail. Consequently, unsolicited communication, especially irrelevant information and too many messages, can provoke both apathy and resentment toward the sender, which can further result in an erosion of brand loyalty over time.

However, there are moments in a customer's relationship with a business, or industry, when they truly desire or even need current and relevant information from a business regarding specific products and services. Perhaps a life event has occurred or the perception of the business has changed. At this point in time, if a company or service vendor contacts the potential customer with the right message, which addresses their current needs or interest, in the right format, and the right criteria for the moment, the chances of a warm reception of the message by the customer will increase. However, the asynchronous nature of typical conventionally employed e-mail marketing activities, do not lend themselves to engaging potential customers with the right message at the right time.

Further, conventional means for gathering information about potential clients for services and products are severely lacking. Direct mail advertising is generally not responded to by most clients unless they have an immediate need for a product or service. Consequently providers of services and products waste time and a great deal of money on postage for a minuscule return.

Direct marketing by telephone has become almost feared by consumers who have either installed answering machines to block such calls, or listed their numbers on a do-not-call list. As such, suppliers of products and services have an equally small return on large scale telephoning efforts. Further, the response is generally not in the democraphic desired since people answering their own phones probably cannot afford the answering machine to shield them.

Even when mail or telephonic marketing does yield a lead, the timeliness of the response and ascertaining the proper response based on the client input can take too much time. Further, since both telephonic marketing and responses to direct mail generally require a human interface between customer and provider, there is the inherent problem of the person listening to the potential customer mis-matching the customer with the service through misunderstanding the client, or poor understanding of the rules in place for response.

Accordingly, there is an unmet need for a system and method to provide a means for customers of goods and services, especially financial services, to acquire timely information about products and services available to them. Such a method should however ascertain the timeframe of the need and whether it is immediate or the potential buyer is just shopping. Such a system should also take into consideration the amount of the potential sale or service and the type of service or product, client seeks.

Such a method should use means to allow the potential client or customer, to actually choose the product or service they are looking for from a menu, and then provide their information, without being overbearing thus encouraging full disclosure from persons who generally avoid such with telephone sales or responses to direct mail. Still further, such a method should allow for employment of supplier-provided rules for subsequent communicating with the potential client based on each individual clients input of information and thereafter initiate steps to put actions into play that will render the proper response to the client based on client-input and the rules in place. Finally, such a method should gather the user-supplied information from the client in a manner which is confidential yet substantially non-obtrusive so that the potential client freely supplies the necessary information to segment their need and timeframe to initiate further actions by potential matched suppliers for the consumer.

### SUMMARY OF THE INVENTION

The disclosed system and method provides for easy and quick compilation of the needs of potential clients for either services such as loans, or products. A client's potential need for any number of services or products, may be easily and voluntarily ascertained, through the provision of user-chosen calculators for specific product, service or financial needs.

The system employing a menu of user chosen need-specific calculators for any number of products or services, allows the user to identify what product or service they are entertaining for purchase by simply picking the relevant calculator for that product or service. The system solves one of the biggest challenges in delivering relevant e-mail messaging by allowing the consumer himself to identify that they are in-market for a product or service. By employing calculators specific to the relevant product or service sought by a customer, and allowing each customer to choose, and therefor identify the product or service they are considering, the customer is given a valued and helpful tool for use in their decision-making process. Concurrently, they are identifying with specificity, exactly what they need or want, and the proximity in time when they plan to acquire it.

In addition to gathering data input by potential customers, the placement of e-mail opt-in/capture forms on each such web-based calculator, provides a natural first step for capturing both the interest of the customer and their e-mail address as a preferred communication channel.

In addition to being timely, relevant e-mail must deliver segmented subject matter appropriate to the customer's needs and qualifications. These customer needs and time frames are ascertained by real-time segmentation capabilities within the calculator platform which can be adapted to allow in-market leads to receive the message most relevant to each individual customer. Segments can be defined based upon user choice of a type of calculator, user calculator inputs or calculated outputs from user inputs, geographic information, demographic data, purchase criteria, intent to purchase, web page visited, or any other data collected during the opt-in process or through the use of the user chosen or used calculator.

The data so generated by the system and method herein is maintained as a unique customer profile which is highly specific to need, timing, type of financing, location, and other factors affecting the potential optimum providers of the needed service. In exchange for the customer's e-mail address, the results of the calculation, as well as other material, can be e-mailed to the customer upon their request. Optionally, the customer may request to receive future e-mail messages, which are relevant to the subject matter of the calculator they chose to use or to the segment they fall into. So for example, a customer choosing to use an auto financing calculator, identifies their own current financial service need and could opt-in for future messaging that is specific to auto loans or related products, but would not be marketed to with e-mail about credit cards or home loans.

Additionally, captured financial need data, client identifiers, and captured e-mail addresses and user profile data can then be forwarded to an appropriate 3rd party processor adapted to provide the very individualized financial need for a potential client identified using above noted factors. Such information would be sent for instance to a call center, loan officer or agent for follow-up or other customer interaction to service provides that match the now very specific identified needs and requirements of the client for both services and time frame and other factors such a geographic location and type of service.

It is thus an object of the invention to provide a system wherein the user or customer freely identifies their desired product or service without the need for a human interface.

It is a further object of this invention to provide a means to identify potential customers for products based upon their choosing of a specific type of financial calculator.

It is a further object of this invention to provide such a system for client identification which allows the potential client to identify their need by providing a menu of product and service specific calculators thereby allowing them to choose and to so identify.

It is a further object of this invention to provide software routines in the calculators provided which segmentize the potential client's needs and wants for the end product, based both on their choice of calculator, and data they input into provided software driven entries.

It is a further object of this invention, from the information ascertained by allowing clients to choose calculators and enter data, to segmentize the clients and match them to vendors for the products most suited to their identified needs.

It is yet a further object of this invention to develop and communicate the matches to vendors in a time frame to make responses communicated by vendors highly relevant as to timing.

These together with other objects and advantages which will become subsequently apparent reside in the details of the web-based financial services and products client lead generation system and method as more fully hereinafter described and claimed, reference being had to the accompanying drawings forming a part thereof, wherein like numerals refer to like parts throughout

### BRIEF DESCRIPTION OF DRAWINGS

FIG. 1 depicts a simple flow of information from consumer to service provider using calculator capture and email.

FIG. 2 is a more detailed depiction of a simple preferred mode of the invention showing processes to segmentize information to distribute it to appropriate responders for timely response.

FIG. 3 shows a typical calculator with input boxes for consumer input of text and data.

FIG. 4 shows a screen generated to inform the consumer the calculation is finished and their results will be sent.

FIG. 5 depicts a simple flow chart of one manner in segmetizing the data gleaned from client input to need-specific chosen calculators and communicating it for a timely and proper response depending on rules.

### DETAILED DESCRIPTION OF DRAWINGS AND PREFERRED EMBODIMENTS

Referring now to the drawings in FIGS. 1-5, FIG. 1 shows a simple form of a web-based service or product calculator employed with the method herein. In the method, a consumer is presented on a webpage with menu for s plurality of need-specific calculators 20 each of which is adapted to provide useable calculations about differing financial services, general services, or products related to the need. For instance the consumer looking for a loan would be presented with a plurality of calculators for different types of loans available. This can include first mortgages, refinances, second or third mortgages, car loans, boat loans, construction loans, etc. For air conditioning, the need-specific calculator would provide BTU information based on the home size input into a data window 22.

In this first step, the consumer is the party who actually identifies the type of loan or product or service for which they are searching by choosing from the menu of need-specific calculators. Since the consumer is the ultimate customer, in an affirmative step, from a plurality of different need-specific web-based displayable electronic calculators, the consumer thus determines the type of loan, product, or service they need. This information is provided even without the consumer employing the calculator since they choose it from a menu having a plurality of calculators suited to different types of loans, services, and products.

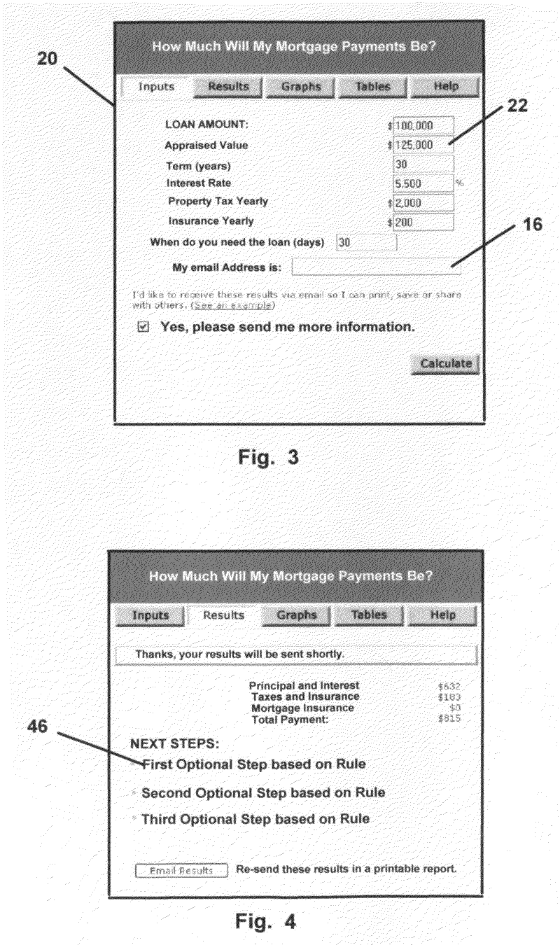

During employment of the need-specific calculator such as that of FIG. 3, the consumer would then identify the amount of money needed for their loan, and the preferred terms, and importantly, input their email address 16 to allow for email delivery 18 of this and other information. Thus, very detailed information, about consumer-identified loan, product, or service requirement, is gathered while the consumer enjoys the free use of the need-specific calculator 20 for planning. In the simplest form of the method, an email follow up 18 is provided based on the input to the input windows 22 and rules of individual product an service vendors providing the services or products identified in the use of the need-specific calculator 20 chosen.

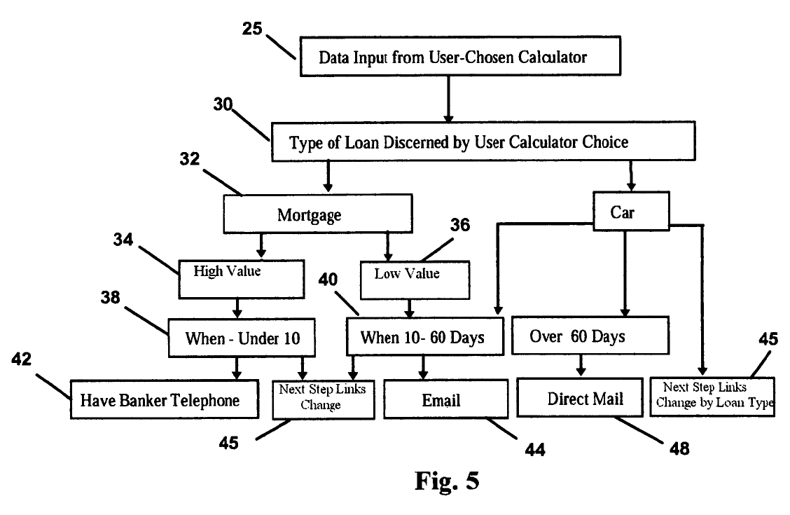

As noted, the need-specific calculator 20 chosen from a menu of such calculators for products and services 10 need not necessarily be about financial services. For example, an air-conditioning need-specific calculator could be offered in the plurality of offered need-specific calculators 20 to allow the consumer to calculate the size of the air-conditioning system needed for their home. Thus, the consumer will identify an upcoming purchase of a product in the form of air conditioning, and the geographic location for the purchase, along with the size of their home. All this data can be forwarded to a local air-conditioning contractor for follow up in a timely fashion based on a set of rules provided by the contractor or vendor. In an example in FIG. 5, data from user input to the need-specific calculator is interpreted 25 to yield the type of loan or product needed 30. From this step, the data may take any number of paths since it must flow to a vendor for the product or service.

For example in FIG. 5 a mortgage loan 32 is extracted from the consumer data based on the need-specific calculator that consumer chose. Based on the input data and rules from the vendor, a high dollar loan 34 with more potential profit takes a different track from a low dollar loan 36. Next, a date proximate for the need of the product or service is ascertained at a more proximate date 38 takes a different track than a more distant date 40.

The communication back to the consumer for the high profit, close in time, loan, may have the banker actually telephone 42 since it is a very high value potentially profitable lead. The communicated data from a consumer for a low value loan more distant, might just get an email 44 since they are not ready to buy yet and perhaps follow up emails.

In a further step, using the rules of response of the vendor, the example of which is shown in FIG. 5, additional links may be provided in the subsequently viewed window of FIG. 4 presented to the consumer after using the need-specific calculator 20 of FIG. 3. These “next steps” may be direct links 45 for an immediate visual communication online with a banker for an near term high value loan 38, or might be a link to a preferred car vendor or vendor of the products being sought 46.

Again, since the need-specific calculators 20 are employed in a host of sites in menus, any number of vendors of products or services may be given data gleaned from the consumer input to the need-specific calculator 20 and which was chosen. The vendors would subscribe to receive this consumer information and would optionally, provide rules (FIG. 5) of their own making, on how the data should initiate a response from their firm. If the response is a telephone call 42, then the vendor would have someone on call ready to make the telephone call when the computer program running the system herein over the Web, gleaned the need under the vendor rules to initiate the call. A message would be sent to the individual making the call immediately. Or if the next step option is to have an online communication with a vendor representative, and is chosen by the consumer, a two-way communication video window would open and put the consumer in contact with an awaiting vendor representative. Or, if direct mail is the proper response according to vendor supplied rules for their product or service, the consumer's input information from the need-specific calculator 20 would be forwarded to the mailing department or services for that vendor.

In an example of employment for a product or tangible service, for example landscaping, a landscaping need-specific calculator 20 could be provided over the Web. The consumer, choosing landscaping need-specific calculator from the plurality of offered product and service calculators, would enter into the data entry windows 22 their lot size, budget, location, etc. and data needed to allow the calculation as well as provide vendors with data to ascertain the value of the consumer's need, the time proximity, the geographic proximity, and other factors allowing calculations for the consumer. Choosing the landscape need-specific calculator 20 the consumer unknowingly identifies themself as a customer for that service and then identify the locale and budget and other information that would be passed to a local services provider, for rules implementation as to a response for their services for landscaping. Most consumers will be unaware they are identifying their need and time frame when entering the data which provides much better data than a consumer responding to telephone marketing or mailers where they are on guard.

Consequently, in the most basic mode of the method herein, the consumer is presented with a plurality of different need-specific product or service calculators 20, from a menu 10 of such plurality of calculators 20, and allowed to choose the need-specific calculator to employ for their calculation. The need-specific calculator 20 chosen, identifies the consumers need without the consumer having to consciously do so, be it a car loan, mortgage, or new air conditioner or landscaping or any other product or service to which a need-specific calculator 20 may be provided in the menu of such calculators.

Data is input by the consumer, who is the best party to know their own need, timing, budget, locale, and other information, excellent and timely data or information is provided in this step. The input data would follow a path of rules based communication and response as in FIG. 5, but of course the rules being established by subscribing vendors can vary infinitely in how the response is communicated back to a consumer.

The web-based need-specific calculator chosen would be a pop up Java type of software operation on the screen or could be a separate webpage or portion thereof. As those skilled in the art realize, the code needed for such calculations based on user input to provided windows 22 may be adapted for virtually any product or service and such is anticipated. The data input windows 22 also provide data entry segmentation by which different inputs by the consumer would be categorized and communicated to subscribing vendors according to the rules of the vendor. The rules of response for the different vendors, may dictate some of the requested information to be input by the consumer into the windows 22.

Once the consumer has input the data and made the calculation, the answers to their input would appear in a second window as in FIG. 4 so the consumer may use the information as needed. In the background the second step can be at this point may be as simple as having software adapted to the task, comparing the consumer chosen need identified in choosing the need-specific calculator 20 from the plurality in the menu, with a data base of providers for the need, and sending the captured information from input windows 22 via a network, to one or a plurality of subscribing providers of the appropriate services or products for a follow up contact. The follow up contact may be based on the vendors rules for timing, valuation, and response or may be simply left to the vendor by simply communicating the data from the input windows 22.

Since the consumer has identified the need, albeit unintentionally, the follow up will be on point, and timely if the vendor has rules for response. Based on the software adapted to determine segmentation of the consumer provided data from the input windows 22, a segmented response to the consumer may also be generated either from the vendor or from the website providing the plurality of user-selectable need-specific calculators.

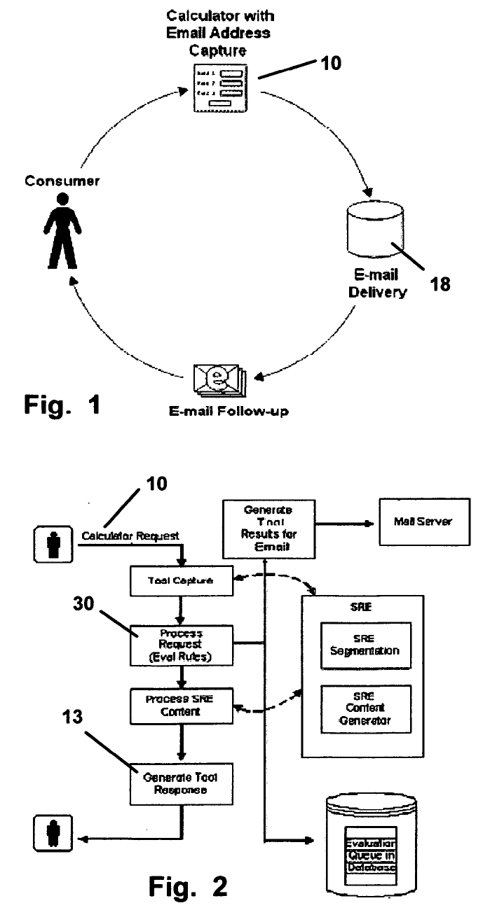

As shown in FIG. 2, which is a more detailed flow chart, the consumer makes a choice or calculator request for one of a plurality of offered need-specific calculators 10 displayed on their computer and screen from a remote server or computer. The need-specific calculator 20 operates as a software tool, to capture the data which the consumer fills into the text entry positions or data entry windows 22 on the need-specific calculator 20 and upon hitting the calculate button as shown in FIG. 3, or some other switching means to capture and process the data, a request is generated to a remote computer on a network to process the data provided using a Segmentation Response Engine or similarly adapted software to receive the data and process the content. A response 13 is generated and emailed to the consumer based on their need and input data if their email is provided.

Based on the need-specific calculator 20 chosen by the consumer to identify the need for a product, and the data input into the input windows 22 provided in the calculator 20, and real-time segmentation capabilities within the calculator platform, in-market leads are generated for forwarding to subscribing providers of the services most relevant to each individual customer.

Segmented responses as noted can be determined based upon user choice of a type of need-specific calculator 20, user calculator inputs or calculated outputs from user inputs, geographic information, demographic data, purchase criteria, intent to purchase, web pages visited, or any other data collected during the opt-in process or through the use of the user chosen or used need-specific calculator 20.

Using software adapted to the task, one or a plurality of appropriate vendors for the service or products matching the captured data from the consumer, are identified and informed of the consumer's need. Using an in house process or rules based process of FIG. 5, the vendors may then timely follow up with the consumer by telephone, online, by email or by other means of communicating their product which will be timely and appropriate for the consumer identified need, and therefor highly likely to be reviewed by the consumer.

While all of the fundamental characteristics and features of the improved disclosed and described financial services and products lead generation system based on the client input from a plurality of offered calculators with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A web-based method for customer lead generation employing the steps of:
from a remote computer communicating over a network, offering a consumer visiting a website, a plurality of different need-specific calculators to enable said client to make calculations on the consumer's computer;
each of said plurality of different need-specific calculators providing calculations one a product or service thereby allowing said consumer to identify need data as their need for a product or service by the need-specific calculator they choose from said plurality;
allowing the consumer to choose the need-specific calculator from said plurality most appropriate to their current real-time need thereby identifying said need data of products or services needed by that consumer;
providing text input boxes in each said need-specific calculator for data input by said consumer;
providing at least one said text input box for said consumer to input an identifier, said identifier providing means for contact with said consumer;
providing a means to indicate the consumer wishes to make a calculation on the chosen need-specific calculator;
allowing said consumer to activate said means to indicate, thereby triggering a transmission of captured data from said text input boxes of the chosen said need-specific calculator;
transmitting said captured data to a subscribing provider of products or services of a type identified by said consumer's choice of need-specific calculator; and
allowing said subscribing provider to provide a response to said consumer.

2. A web-based method for customer lead generation of claim 1 additionally comprising the steps of:
employing a set of rules for said response, said rules provided by said subscribing provider to whom said captured data is transmitted, to dictate an appropriate said response from a plurality of responses including one or a combination of email, direct mail, telephone calls, and online immediate two-way communication.

3. A web-based method for customer lead generation of claim 1 additionally comprising the steps of:
based on the type of product or service identified as needed by the consumer's choice of a said need-specific calculator, providing links to other web pages in a subsequent computer generated screen presented to said consumer subsequent to said consumer triggering said transmission.

4. A web-based method for customer lead generation of claim 2 additionally comprising the steps of:
based on the type of product or service identified as needed by the consumer's choice of a said need-specific calculator, and said rules provided by said subscribing provider, providing links to other web pages in a subsequent computer generated screen presented to said consumer subsequent to said consumer triggering said transmission.

5. A web-based method for customer lead generation of claim 1 additionally comprising the steps of:
employing software adapted to the task to input said captured data, and thereafter determine a segmentation for said consumer's need identified by said choice of a need-specific calculator; and
communicating said captured data, and said identifier, to a provider of services or products matching the segmentation determined for said consumer, whereby said provider may initiate a timely said response with said consumer regarding said products or services.

6. The web-based method for customer lead generation of claim 5 additionally comprising the steps of:
employing a set of rules for said response, said rules provided by said subscribing provider to whom said captured data is transmitted, to dictate an appropriate said response from a plurality of responses including one or a combination of email, direct mail, telephone calls, and online immediate two-way communication.

7. The method of claim 5 wherein said services are loans and said segmentation is one of a plurality of different types of loans from different of said providers.

8. The method of claim 6 wherein said services are loans and said segmentation is one of a plurality of different types of loans from different of said providers.

9. The method of claim 7 wherein said services are loans and said segmentation includes separating loans needed in a near term from loans identified as needed in a later term; and
directing one type of response for said loans needed in the near term and a second type of response for said loans needed in said later term.
